(19) United States
(12) Patent Application Publication
(10) Pub. No.: US 2019/0162138 A1
(43) Pub. Date: May 30, 2019

(54) VAPORIZED FUEL PROCESSING DEVICE

(71) Applicant: TOYOTA JIDOSHA KABUSHIKI KAISHA, Toyota-shi (JP)

(72) Inventor: Noriyasu MISHIMA, Toyota-shi (JP)

(73) Assignee: TOYOTA JIDOSHA KABUSHIKI KAISHA, Toyota-shi (JP)

(21) Appl. No.: 16/145,882

(22) Filed: Sep. 28, 2018

(30) Foreign Application Priority Data
Nov. 24, 2017 (JP) 2017-226183

(51) Int. Cl. F02M 25/08

(52) U.S. Cl. CPC F02M 25/0836; F02M 25/0872

(57) ABSTRACT

A vaporized fuel processing device includes a piping portion, a bracket fixed to an engine, and a check valve disposed in the piping portion. The piping portion has flexibility, the bracket includes a support wall portion protruding in a direction away from the engine, and the support wall portion includes a hole. The check valve includes a pawl portion engaged with the hole, and a support portion configured to support the check valve such that the check valve is suspended by the bracket. The support wall portion includes an edge portion protruding away from the engine beyond a position where the check valve is supported, and the pawl portion elastically deforms to an extent that the pawl portion is disengaged from the hole when the support portion is inclined toward the engine in a state in which the pawl portion is engaged with the hole.

### INCORPORATION BY REFERENCE

The disclosure of Japanese Patent Application No. 2017-226183 filed on Nov. 24, 2017 including the specification, drawings and abstract is incorporated herein by reference in its entirety.

### BACKGROUND

### 1. Technical Field

The disclosure relates to a vaporized fuel processing device.

### 2. Description of Related Art

A vaporized fuel processing device which supplies a vaporized fuel adsorbed onto a canister in a fuel tank to an intake system of an engine is known. For example, in Japanese Unexamined Patent Application Publication No. 2017-141719 (JP 2017-141719 A), a bracket is fixed to a side member which is a vehicle constituent member, and a piping portion that causes a canister and an intake system of an engine to communicate with each other is fastened to the bracket.

### SUMMARY

In a case where a check valve is provided in the piping portion described above, there is a possibility that a component on a vehicle side may collide with the check valve and be damaged at the time of a vehicle collision.

The disclosure provides a vaporized fuel processing device which suppresses damage of a check valve at the time of a vehicle collision.

An aspect of the disclosure relates to a vaporized fuel processing device. The vaporized fuel processing device includes: a piping portion which constitutes a portion of a purge passage that causes an intake system of an engine mounted in a vehicle and a canister to communicate with each other; a bracket fixed to the engine; and a check valve disposed in the piping portion. The piping portion has flexibility, the bracket includes a support wall portion protruding in a direction away from the engine, and the support wall portion includes a hole. The check valve includes a pawl portion configured to be engaged with the hole and a support portion configured to support the check valve such that the check valve is suspended by the bracket. The support wall portion includes an edge portion protruding away from the engine beyond a position where the check valve is supported, and the pawl portion is configured to elastically deform to an extent that the pawl portion is disengaged from the hole when the support portion is inclined toward the engine in a state in which the pawl portion is engaged with the hole.

The check valve is supported by the bracket fixed to the engine. Therefore, at the time of a vehicle collision, the engine serves as a barrier, so that a vehicle side component is prevented from colliding with the check valve from the engine side. The support wall portion includes an edge portion protruding away from the engine beyond a position where the check valve is supported. Therefore, at the time of a vehicle collision, the edge portion serves as a barrier, so that the vehicle side component is prevented from colliding with the check valve from a side opposite to the engine. The piping portion has flexibility. Therefore, at the time of a vehicle collision, even in a case where the vehicle side component collides with the piping portion, the piping portion is bent, so that a load applied to the check valve is suppressed. The pawl portion is configured to elastically deform to an extent that the pawl portion is disengaged from the hole when the support portion is inclined toward the engine in a state in which the pawl portion is engaged with the hole. Therefore, even in a case where the vehicle side component collides with the piping portion at the time of a vehicle collision and the support portion is inclined toward the engine, the support portion is disengaged from the bracket together with the check valve, so that a load applied to the check valve is suppressed. As described above, damage to the check valve at the time of a vehicle collision is prevented.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view illustrating a vaporized fuel processing device according to an embodiment;

FIG. 2A is an enlarged view illustrating the vicinity of a check valve;

FIG. 2B is an enlarged view illustrating the vicinity of the check valve;

FIG. 3A is an exemplary view of a case where a vehicle side component collides with a bracket at the time of a vehicle collision;

FIG. 3B is an exemplary view of a case where the vehicle side component collides with hoses at the time of a vehicle collision;

FIG. 4A is an explanatory view of a support band in a case of being viewed from the rear side of a vehicle; and

FIG. 4B is an explanatory view of the support band in a case of being viewed from the right side of the vehicle.

### DETAILED DESCRIPTION OF EMBODIMENTS

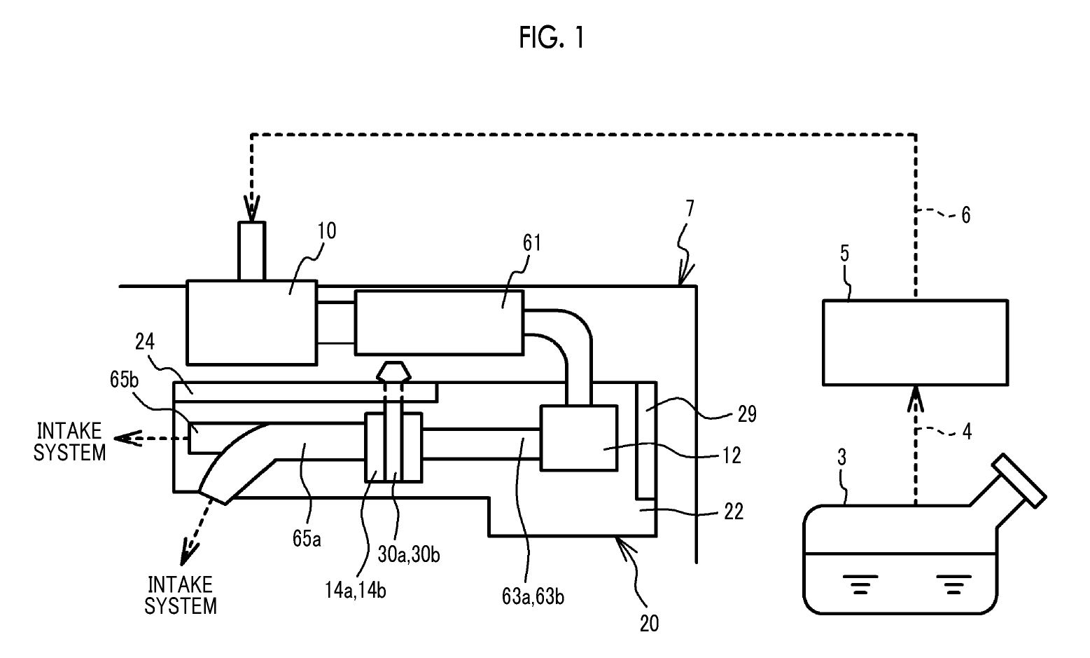

FIG. 1 is a schematic view illustrating a vaporized fuel processing device according to an embodiment. The vaporized fuel processing device is mounted in a vehicle. The vaporized fuel processing device has hoses 63a, 63b, 65a, 65b, check valves 14a, 14b, a bracket 20, support bands 30a, 30b, and the like. The hoses 63a, 63b, 65a, 65b constitute a portion of a purge passage 6. The hoses 63a, 63b overlap in a direction into the surface of FIG. 1, and the same is applied to the check valves 14a, 14b and the hoses 65a, 65b. The purge passage 6 causes an intake system of an engine 7 mounted in the vehicle and a canister 5 to communicate with each other. The canister 5 communicates with a fuel tank 3 via a vapor passage 4, and a fuel vapor flows from the fuel tank 3 into the canister 5 side via the vapor passage 4. The canister 5 stores an adsorbent such as activated carbon that adsorbs a fuel therein. The fuel tank 3 stores the fuel supplied to the engine 7.

A purge vacuum switching valve (VSV) 10, a branch pipe 12, and the check valves 14a, 14b are disposed on the purge passage 6. The purge VSV 10 is an electromagnetic valve for controlling a purge flow rate and communicates with the branch pipe 12 via a hose 61. The two branching hoses 63a, 63b are connected to the branch pipe 12. The check valves 14a, 14b are respectively connected to downstream end portions of the hoses 63a, 63b. The check valves 14a, 14b allow the flow of a fluid from the canister 5 side toward the engine 7 while restricting the flow in a reverse direction. The check valves 14a, 14b are made of a synthetic resin, but are not limited thereto. The check valves 14a, 14b may also be made of a metal. The hoses 65a, 65b are respectively connected to downstream end portions of the check valves 14a, 14b. The hoses 61, 63a, 63b, 65a, 65b are made of a rubber having flexibility, but may also be made of a plastic having flexibility. For example, the hose 65a is connected to a downstream side of a throttle valve of an intake passage, and the hose 65b is connected to a side upstream of a compressor wheel of the intake passage.

The bracket 20 is fixed to the engine 7 side and is made of a metal having high rigidity. The bracket 20 includes a fixed wall portion 22, a support wall portion 24, and a protective wall portion 29. The fixed wall portion 22 is fixed to a side surface of the engine 7. The support wall portion 24 protrudes in a direction substantially perpendicular to the fixed wall portion 22. In other words, the support wall portion 24 protrudes from the fixed wall portion 22 toward the opposite side of the engine 7. The protective wall portion 29 protrudes in a direction substantially perpendicular to the fixed wall portion 22 and faces the branch pipe 12. The support wall portion 24 extends in a substantially horizontal direction, whereas the protective wall portion 29 extends in a substantially vertical direction. The check valves 14a, 14b are supported between the fixed wall portion 22 and the support wall portion 24 to be suspended from the support wall portion 24 by the support bands 30a, 30b, respectively. The support bands 30a, 30b are also disposed to overlap in the direction into the surface of FIG. 1. As will be described in detail later, the support bands 30a, 30b are respectively engaged with holes provided in the support wall portion 24. The support wall portion 24 is formed to extend above the hoses 65a, 65b but is not formed above the hoses 63a, 63b. The support bands 30a, 30b are an example of a support portion that supports each of the check valves 14a, 14b to be suspended by the bracket 20.

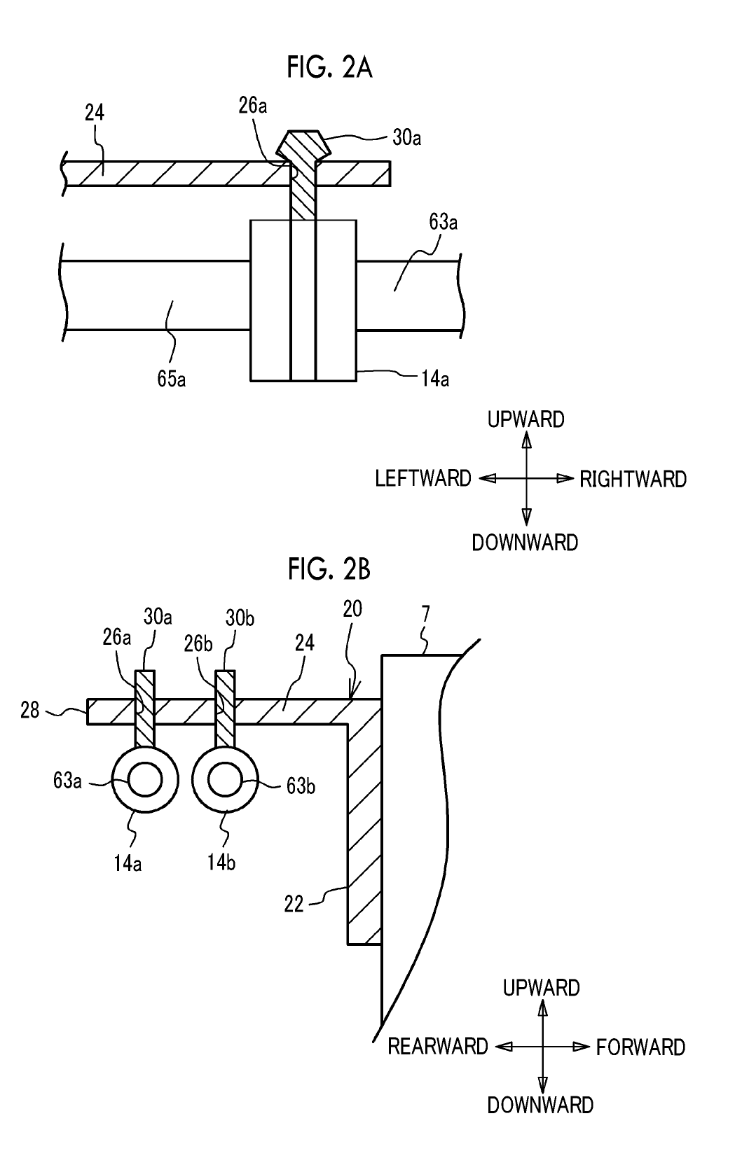

FIG. 2A is an enlarged view illustrating the vicinity of the check valve 14a. FIG. 2B is an enlarged view illustrating the vicinity of the check valves 14a, 14b, and upward, downward, leftward, rightward, forward, and rearward arrows shown in FIGS. 2A and 2B respectively represent the upper side, the lower side, the right side, the left side, the front side, and the rear side of the vehicle. FIG. 2A illustrates a case where the check valve 14a is viewed from the rear side of the vehicle. FIG. 2B illustrates a case where the check valves 14a, 14b are viewed from the right side of the vehicle. In FIG. 2A, a portion of the support band 30a and a portion of the support wall portion 24 are shown in a cross-section. In FIG. 2B, the support bands 30a, 30b and the bracket 20 are shown in a cross-section. The support bands 30a, 30b are respectively engaged with the holes 26a, 26b formed in the support wall portion 24 of the bracket 20. The support wall portion 24 has an edge portion 28 protruding away from the engine 7 beyond positions where the holes 26a, 26b are formed. In other words, the edge portion 28 protrudes toward the rear side of the vehicle. As illustrated in FIGS. 2A and 1, the support wall portion 24 does not extend above the hoses 63a, 63b.

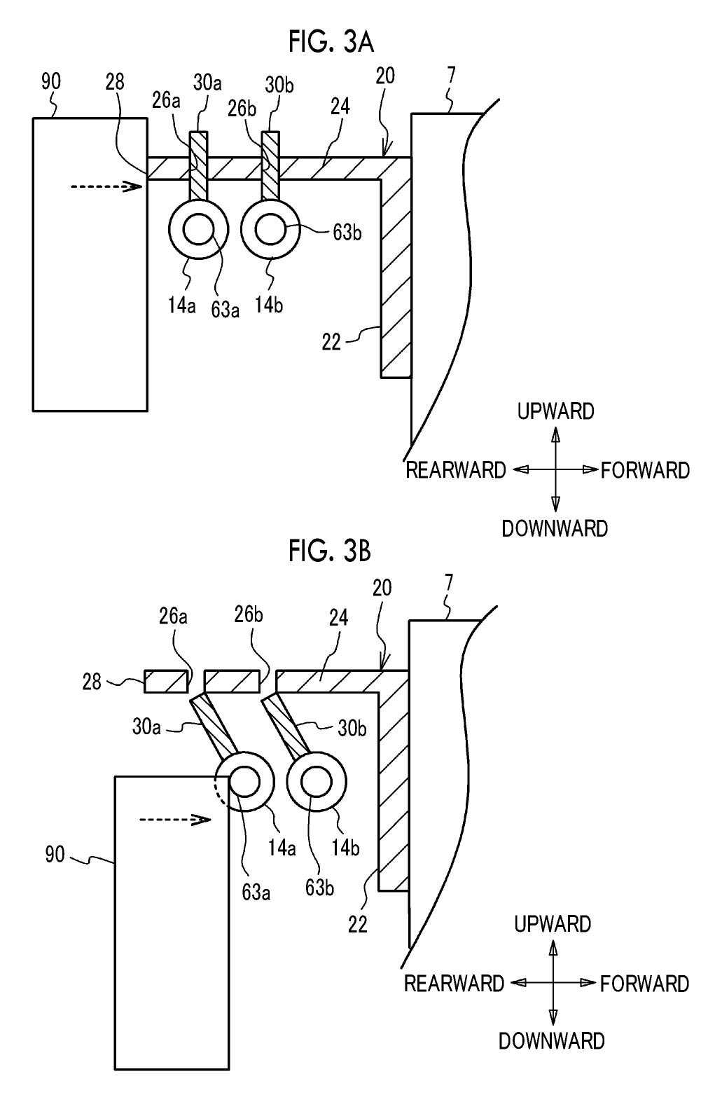

A collision of the vehicle will be described. FIG. 3A is an exemplary view of a case where a vehicle side component (hereinafter, simply referred to as “component”) 90 collides with the bracket 20 at the time of a vehicle collision. The component 90 is, for example, a component provided in an engine compartment or a frame member included in a vehicle body. As illustrated in FIG. 3A, at the time of a collision, there may be a case where the component 90 disposed on the opposite side of the position to which the bracket 20 is fixed from the engine 7 collides with the bracket 20. Particularly, the situation described above can occur at the time of a forward collision. Here, the edge portion 28 of the support wall portion 24 of the bracket 20 protrudes away from the engine 7 beyond positions where the check valves 14a, 14b are supported, that is, toward the rear side of the vehicle. Accordingly, the edge portion 28 serves as a barrier, and the component 90 collides with the edge portion 28, thereby preventing the component 90 from directly colliding with the check valves 14a, 14b. In the manner as described above, damage to the check valves 14a, 14b is prevented.

FIG. 3B is an exemplary view of a case where the vehicle side component 90 collides with the hoses 63a, 63b at the time of a vehicle collision. As illustrated in FIG. 3B, there may be a case where the component 90 collides with the hoses 63a, 63b. This is because, as described above, the support wall portion 24 is not formed above the hoses 63a, 63b and contact between the component 90 and the hoses 63a, 63b cannot be prevented by the support wall portion 24. When the component 90 collides with the hoses 63a, 63b, the hoses 63a, 63b move while being bent toward the engine 7. As described above, the check valves 14a, 14b and the hoses 65a, 65b move toward the engine 7, and the support bands 30a, 30b are inclined toward the engine 7. As will be described in detail later, when the support bands 30a, 30b are inclined toward the engine 7, the support bands 30a, 30b are respectively disengaged from the holes 26a, 26b, and the check valves 14a, 14b fall off of the bracket 20. As described above, due to the bending of the hoses 63a, 63b, a load applied to the check valves 14a, 14b via the hoses 63a, 63b is suppressed. The load applied to the check valves 14a, 14b is suppressed and damage is prevented even by the disengagement of the support bands 30a, 30b from the holes 26a, 26b. Since the hoses 63a, 63b, 65a, 65b have flexibility, damage to the hoses 63a, 63b, 65a, 65b themselves is also prevented.

The check valves 14a, 14b are supported by the bracket 20 fixed to the engine 7. In other words, the check valves 14a, 14b face the engine 7 with the bracket 20 interposed therebetween. Here, the engine 7 has higher rigidity than a vehicle constituent member such as a side member. Accordingly, the engine 7 having higher rigidity serves as a barrier, and the vehicle side component is prevented from colliding with the check valves 14a, 14b from the engine 7 side. As described above, damage to the check valves 14a, 14b is prevented even by the engine 7.

By various configurations described above, damage to the check valves 14a, 14b is prevented. Regarding the bracket 20, with a simple configuration in which the edge portion 28 of the bracket 20 protrudes in a direction away from the engine 7 above the check valves 14a, 14b, damage to the check valves 14a, 14b is prevented. Accordingly, since damage to the check valves 14a, 14b can be prevented by the bracket 20 with a minimal size, an increase in size of the bracket 20 is suppressed, and reductions in weight and costs are achieved. By the protective wall portion 29 illustrated in FIG. 1, damage to the branch pipe 12 is prevented at the time of a vehicle collision.

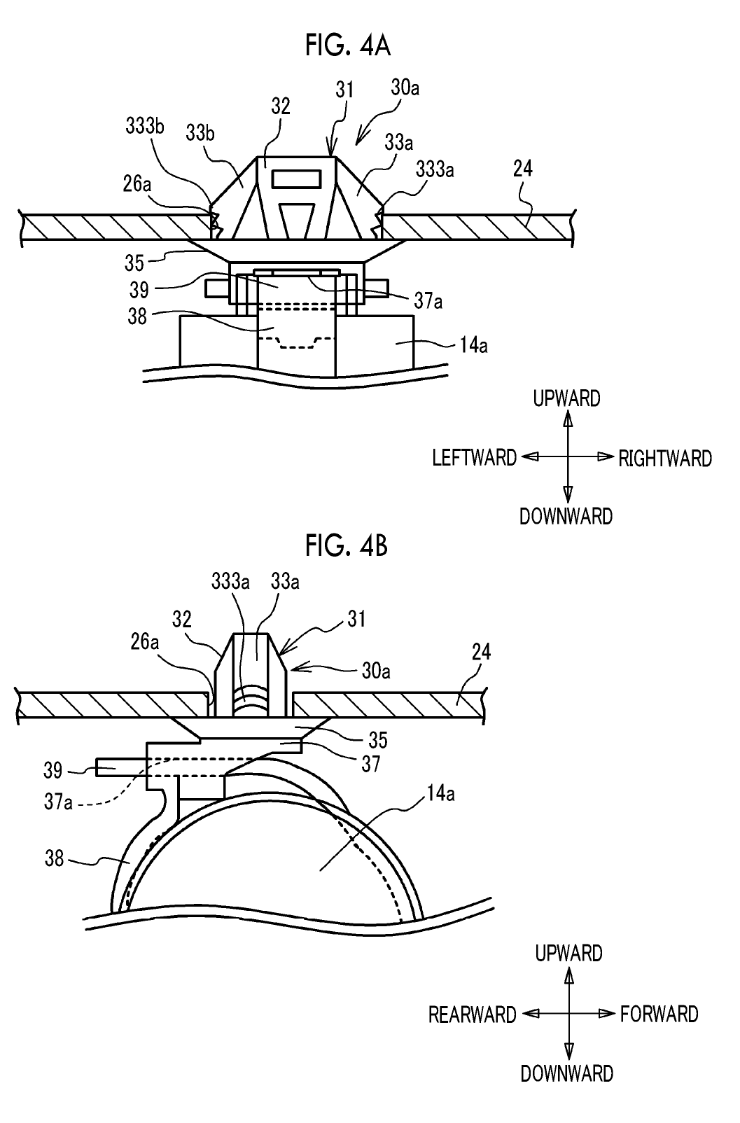

The support band 30a will be described in detail. Since the support band 30b has the same configuration as the support band 30a, descriptions thereof will be omitted. FIG. 4A is an explanatory view of the support band 30a in a case of being viewed from the rear side of the vehicle, and FIG. 4B is an explanatory view of the support band 30a in a case of being viewed from the right side of the vehicle. The support band 30a has, in order from one end to the other end, a clip portion 31, a sucker portion 35, a strap portion 37, and a band portion 38. The support band 30a is made of a synthetic resin, and the band portion 38 has a thin band shape and is soft. The clip portion 31 is inserted into and engaged with the hole 26a of the support wall portion 24. The sucker portion 35 is positioned under the clip portion 31 and is adsorbed onto the lower surface of the support wall portion 24.

An insertion hole 37a is formed in the strap portion 37. The band portion 38 surrounds the outer circumference of the check valve 14a. A tip end portion 39 of the band portion 38 is inserted into the insertion hole 37a. A locking piece is provided inside the insertion hole 37a. On one surface of the band portion 38, a comb-shaped uneven portion is formed along a longitudinal direction thereof. In the insertion hole 37a, the locking piece is engaged with the uneven portion of the band portion 38, thereby preventing the band portion 38 from coming off from the insertion hole 37a. The check valve 14a is supported by the support band 30a to be suspended from the support wall portion 24 as described above.

The clip portion 31 has a column portion 32 provided at the center portion of the sucker portion 35, and pawl portions 33a, 33b which are provided to be connected to upper end portions of the column portion 32. The pawl portions 33a, 33b are provided with the column portion 32 interposed therebetween in a right-left direction of the vehicle. The right-left direction of the vehicle is a direction in which the support band 30a becomes distant from the engine 7. Accordingly, the pawl portions 33a, 33b are an example of a first pawl portion and a second pawl portion which are separated from each other in the direction in which the support band 30a becomes distant from the engine 7. The pawl portions 33a, 33b are formed so as to be elastically deformable about root portions connected to the column portion 32. The tip end portions of the pawl portions 33a, 33b respectively come into contact with portions of inner edges of the holes 26a, and a state in which the pawl portions 33a, 33b and the inner edges of the holes 26a are engaged with each other is maintained by the elastic restoring force of the pawl portions 33a, 33b. Specifically, as illustrated in FIG. 4A, a plurality of locking stepped portions 333a and a plurality of locking stepped portions 333b are respectively formed at tip end sides of the pawl portions 33a, 33b. As illustrated in FIG. 4B, the locking stepped portion 333a is formed in an arc shape about the position of the sucker portion 35 or the strap portion 37. The same is applied to the locking stepped portion 333b. The hole 26a has an elongated hole shape in which the length in the right-left direction of the vehicle is longer than the width in a front-rear direction of the vehicle so as to correspond to the shape of the clip portion 31.

The engagement of the pawl portions 33a, 33b with the holes 26a is maintained by the elastic restoring force in the right-left direction of the vehicle. Therefore, the support band 30a is prevented from being inclined in the right-left direction of the vehicle, so that the disengagement of the support band 30a from the hole 26a is prevented. Contrary to this, as illustrated in FIG. 4B, the clip portion 31 is not provided with a pawl portion or the like that imparts an elastic restoring force to the inner edge of the hole 26a in the front-rear direction of the vehicle. Therefore, it becomes easy for the support band 30a to be inclined in the front-rear direction of the vehicle. Here, in a case where an external force to cause the support band 30a to be inclined in the front-rear direction of the vehicle is applied in a state in which the pawl portions 33a, 33b are engaged with the holes 26a, the pawl portions 33a, 33b elastically deform to approach the column portion 32 against the elastic restoring force of the locking stepped portions 333a, 333b and slide on the inner edges of the holes 26a. As described above, the engagement of the locking stepped portions 333a, 333b with the inner edges of the holes 26a is released, so that the clip portion 31 is disengaged from the hole 26a by the weight of the check valve 14a and the like. In the manner as described above, in a case where an external force to cause the support band 30a to be inclined in the right-left direction of the vehicle, the engagement with the hole 26a is maintained, and in a case where an external force to cause the support band 30a to be inclined in the front-rear direction of the vehicle, the support band 30a is disengaged from the hole 26a.

In the vaporized fuel processing device according to the aspect of the disclosure, the check valve may be made of a synthetic resin.

In the vaporized fuel processing device according to the aspect of the disclosure, the support portion may include the first pawl portion and the second pawl portion which are separated from each other in the direction in which the support wall portion becomes distant from the engine.

According to the disclosure, it is possible to provide a vaporized fuel processing device capable of preventing damage of a check valve at the time of a vehicle collision.

While the embodiment of the disclosure has been described above in detail, the disclosure is not limited to such a specific embodiment, and various modifications and changes can be made without departing from the gist of the disclosure described in the claims.

In the embodiment described above, the support band 30a and the check valve 14a are separate members but may also be integrally provided. In a case where the support band 30a and the check valve 14a are integrally provided, a portion of the support band 30a corresponding to the clip portion 31 may be provided to protrude from the outer circumferential surface of the check valve 14a.

In the embodiment described above, the fixed wall portion 22 of the bracket 20 is directly fixed to the side surface of the engine 7. However, the fixed wall portion 22 is not limited thereto and may also be fixed to the engine 7 side via another bracket or the like. The fixed wall portion 22 and the support wall portion 24 of the bracket 20 are not limited to integral formation, and a metal plate forming the fixed wall portion 22 and a metal plate forming the support wall portion 24 may be formed as separate bodies so as to be fastened to each other by bolts or the like.

In the embodiment described above, the support wall portion 24 is provided to extend above the hoses 65a, 65b. However, the support wall portion 24 is not limited thereto, and may also be formed to be positioned solely above the check valves 14a, 14b.

In the embodiment described above, the bracket 20 and the check valves 14a, 14b are disposed closer to the rear side of the vehicle than the engine 7 but are not limited thereto.

What is claimed is:

1. A vaporized fuel processing device comprising:
a piping portion which constitutes a portion of a purge passage that causes an intake system of an engine mounted in a vehicle and a canister to communicate with each other, the piping portion having flexibility;
a bracket fixed to the engine, the bracket including a support wall portion protruding in a direction away from the engine, and the support wall portion including a hole; and
a check valve disposed in the piping portion, the check valve including a pawl portion configured to be engaged with the hole, and a support portion configured to support the check valve such that the check valve is suspended by the bracket, wherein:
the support wall portion includes an edge portion protruding away from the engine beyond a position where the check valve is supported; and
the pawl portion is configured to elastically deform to an extent that the pawl portion is disengaged from the hole when the support portion is inclined toward the engine in a state in which the pawl portion is engaged with the hole.

2. The vaporized fuel processing device according to claim 1, wherein the check valve is made of a synthetic resin.

3. The vaporized fuel processing device according to claim 1, wherein the support portion includes a first pawl portion and a second pawl portion which are separated from each other in a direction in which the support wall portion becomes distant from the engine.
